(19) United States
(12) Patent Application Publication
(10) Pub. No.: US 2024/0202399 A1
(43) Pub. Date: Jun. 20, 2024

(54) WET ETCHING PROCESS-BASED MODELING METHOD AND SEMICONDUCTOR DEVICE MANUFACTURING METHOD

(71) Applicant: CANSEMI TECHNOLOGY INC., Guangzhou, Guangdong (CN)

(72) Inventors: Ruijing HAN, Guangzhou, Guangdong (CN); Hui ZENG, Guangzhou, Guangdong (CN)

(21) Appl. No.: 18/555,176

(22) PCT Filed: Dec. 28, 2021
(86) PCT No.: PCT/CN2021/142021

§ 371 Date: Oct. 12, 2023

(30) Foreign Application Priority Data
Apr. 14, 2021 (CN) 202110402308.9

(51) Int. Cl. G06F 30/20; G06F 113/08; G06F 113/18; H01L 21/306

(52) U.S. Cl. CPC G06F 30/20; H01L 21/30604; G06F 2113/08; G06F 2113/18

(57) ABSTRACT

A method of modeling a wet etching process and a method of manufacturing a semiconductor device are disclosed. The modeling method includes: establishing partial differential equations of a reaction-diffusion system for chemical reactions involved in the wet etching process which is performed on a wafer surface using a mixed acid solution; obtaining formulas for the chemical reaction functions by applying the Brusselator model thereto; linearizing and expanding the formulas for the chemical reaction functions and thereby determining conditions for developing a chemical clock for the chemical reactions; calculating simulation parameters of the formulas for the chemical reaction functions; determining diffusion coefficients in the spatial diffusion terms, which allow formation of dome-shaped micro-cavities, thereby obtaining a mathematical model of the reaction-diffusion system for the chemical reactions involved in the wet etching process on the wafer surface. With the present invention, an optimal mixture ratio of the mixed acid solution can be rapidly and accurately determined, which enables formation of morphologically optimal dome-shaped micro-cavities on the wafer surface as a result of the etching process and hence improved performance of the semiconductor device being fabricated.

### TECHNICAL FIELD

The present invention relates to the field of integrated circuit fabrication and, in particular, to a method of modeling a wet etching process and a method of manufacturing a semiconductor device.

### BACKGROUND

In the process of semiconductor device manufacturing, wet etching, as a fundamental and critical technique, has been widely used in practical production. Wet etching usually follows spin coating, exposure and development of photoresist and involves chemical reactions between a liquid chemical reagent (typically mixed acids) with wafer surface regions not protected by the photoresist, which result in a particular structure. After that, the photoresist on the surface is removed in a photoresist stripper, and unwanted residuals are then washed off in a cleaner, followed by delivery to the next station. One of the characteristics of wet etching is isotropy of the liquid chemical reagent used. Moreover, such liquid chemical reagents show very high etch selectivity, low cost, suitability for mass-production and other desirable properties and are therefore extensively used in semiconductor device fabrication.

For example, in order to fabricate a vertical power MOSFET device, a wet etching process may be employed to thin a substrate on the backside of a wafer to control the length of a drift region to be formed between a source and a drain to a desired value. After the substrate is thinned, metal sputtering may be utilized to form on the substrate a metal electrode for the application of an external voltage thereto. Moreover, in the wet etching process for thinning the substrate, dome-shaped cavities may be formed on the substrate surface, which result in a larger contact area with the metal electrode formed of the sputtered metal and hence increased overall adhesion at the interface. The formation of dome-shaped cavities would be affected by many factors including etching temperature, mixture ratio of the mixed acids and fluidity of the liquid, and is believed to be a result of dome-shaped voids formed in the substrate surface by geometrically identical bubbles arising from saturation of gaseous products in the solution of the reactions between the mixed acids and the substrate. Therefore, for morphological optimization of the dome-shaped cavities on the substrate surface as a result of the etching process, the mixture ratio of the mixed acids is considered to be the most important factor.

However, due to high complexity of the reactions between the mixed acids and the substrate, it seems impossible to identify the best mixture ratio of the mixed acids through experimental design. Therefore, there is a need for method of modeling a wet etching process and a method of manufacturing a semiconductor device, which can rapidly and accurately determine an optimal mixture ratio for mixed acids and hence achieve morphological optimization of dome-shaped cavities on a surface of a substrate on the backside of a wafer.

### SUMMARY OF THE INVENTION

It is an objective of the present invention to provide a method of modeling a wet etching process and a method of manufacturing a semiconductor device, which can rapidly and accurately identify an optimal mixture ratio for a mixed acid solution. As a result, dome-shaped micro-cavities with optimal morphology can be formed on a wafer surface by the etching process, resulting in enhanced performance of the resulting semiconductor device.

To this end, the present invention provides a method of modeling a wet etching process, which includes:
establishing partial differential equations of a reaction-diffusion system for chemical reactions involved in the wet etching process which is performed on a wafer surface using a mixed acid solution, wherein each of the partial differential equations is the summation of a chemical reaction function and a spatial diffusion term;
obtaining formulas for the chemical reaction functions by applying the Brusselator model thereto;
linearizing and expanding the formulas for the chemical reaction functions and thereby determining conditions for developing a chemical clock for the chemical reactions in the wet etching process;
based on the conditions, calculating simulation parameters of the formulas for the chemical reaction functions; and
determining diffusion coefficients in the spatial diffusion terms, which allow formation of dome-shaped micro-cavities, so that the partial differential equations represent a mathematical model of the reaction-diffusion system for the chemical reactions involved in the wet etching process on the wafer surface.

Optionally, the partial differential equations may be

$$\frac{\partial X}{\partial t} = {f}_{X} ( X , Y ) + {D}_{X} {∇}^{2} X$$

$$\frac{\partial Y}{\partial t} = {f}_{Y} ( X , Y ) + {D}_{Y} {∇}^{2} Y$$

where ƒ_{X} (X, Y) and ƒ_{Y} (X, Y) are the chemical reaction functions, D_{X}∇²X and D_{Y}∇²Y are the spatial diffusion terms, D_{X} and D_{Y} are diffusion coefficients of an activator and an inhibitor, respectively, ∇² is the Laplace operator, and X and Y are concentrations of the activator and the inhibitor, respectively.

Optionally, the mixed acid solution may contain nitric acid and the wafer surface may be a silicon surface, wherein the chemical reactions involved in the wet etching process which is performed on the wafer surface using the mixed acid solution include:

$${HNO}_{3} + {H}^{+} {{⇌}_{{k}_{- 5}}}^{{k}_{5}} {NO}_{2}^{+} + {H}_{2} O$$

$${NO}_{2}^{+} + {e}^{-} {{⇌}_{{k}_{- 6}}}^{{k}_{6}} {NO}_{2}$$

$${NO}_{2} + {H}_{3}^{+} O {{⇌}_{{k}_{- 7}}}^{{k}_{7}} {HNO}_{2} + {H}_{2} O$$

$${HNO}_{3} + 2 NO + {H}_{2} O {\to }^{{k}_{8}} 3 {HNO}_{2}$$

$$2 {HNO}_{2} + Si {\to }^{{k}_{9}} {SiO}_{2} + {N}_{2} O + {H}_{2} O$$

$${N}_{2} O + 4 {NO}_{2} + 3 {H}_{2} O {\to }^{{k}_{10}} 6 {HNO}_{2}$$

where k₅, k₋₅, k₆, k₋₆, k₇, k₋₇, k₈, k₉ and k₁₀ are reaction constants, and HNO₂ is identified as the activator and N₂O as the inhibitor according to the Brusselator model.

Optionally, the formulas for the chemical reaction functions obtained by applying the Brusselator model thereto may be

$${f}_{X} ( X , Y ) = {k}_{8} {C}_{{HNO}_{3}} {C}_{NO}^{2} + {k}_{7} {C}_{{NO}_{2}} - {k}_{- 7} X - {k}_{9} {X}^{2} + \frac{{k}_{10}}{{k}_{7}^{4}} {X}^{4} Y$$

$${f}_{Y} ( X , Y ) = {k}_{9} {X}^{2} - \frac{{k}_{10}}{{k}_{7}^{4}} {X}^{4} Y$$

$$where$$

$${k}_{7} = \frac{[ {HNO}_{2} ]}{[ {NO}_{2} ]} = \frac{{C}_{{HNO}_{2}}}{{C}_{{NO}_{2}}} = \frac{X}{{C}_{{NO}_{2}}} ,$$

and C_{HNO}_{₃} [symbol] C_{NO} [symbol] C_{NO}_{₂}, C_{HNO}_{₃} [symbol] C_{NO} [symbol] C_{NO}_{₂}, C_{HNO}_{₃} [symbol] C_{NO} [symbol] C_{NO}_{₂} and C_{HNO}_{₂} are molar concentrations of HNO₃, NO, NO₂ and HNO₂, respectively.

Optionally, determining the conditions for developing a chemical clock for the chemical reactions in the wet etching process may include:
normalizing reaction coefficients in the formulas for the chemical reaction functions, thereby simplifying the formulas for the chemical reaction functions into:

$${f}_{X} ( X , Y ) = C - AX - {X}^{2} + {BX}^{4} Y ,$$

$${f}_{Y} ( X , Y ) = {X}^{2} - {BX}^{4} Y ,$$

$$where$$

$$A , B , C are the simulation parameters ;$$

linearizing and expanding the simplified formulas for the chemical reaction functions, thereby further simplifying the formulas for the chemical reaction functions into:

$${f}_{X} ( X , Y ) = aX + bY ,$$

$${f}_{Y} ( X , Y ) = cX + dY ;$$

letting the linearized and expanded formulas for the chemical reaction functions satisfy the following equations at a pole (X₀, Y₀):

$${f}_{X} ( {X}_{0} , {Y}_{0} ) = 0 ,$$

$${f}_{Y} ( {X}_{0} , {Y}_{0} ) = 0 ;$$

according to the nonlinear system theory, determining the conditions for developing a chemical clock for the chemical reactions as the following conditions for the system to have a limit cycle around the pole (X₀, Y₀):

$$a + d = 0 ,$$

$$ad - bc > 0 .$$

Optionally, calculating the simulation parameters of the formulas for the chemical reaction functions may include:
measuring an amount of silicon etched away from the wafer surface;
estimating ranges of the reaction constants based on the measurement;
calculating the reaction constants based on the estimated ranges according to the equations satisfied at the pole and the conditions for obtaining a limit cycle around the pole; and
calculating the simulation parameters of the formulas for the chemical reaction functions based on the calculated reaction constants and on the normalization of the reaction coefficients in the formulas for the chemical reaction functions.

Optionally, determining the diffusion coefficients in the spatial diffusion terms, which allow formation of dome-shaped micro-cavities, may include:
with the calculated reaction constants being kept constant, estimating diffusion coefficients of the activator and the inhibitor from an actual viscosity measurement of the mixed acid solution as initial values and performing a simulation process using a difference iteration approach such that the activator and the inhibitor exhibit spatially periodic concentration profiles, thereby determining the diffusion coefficients of the activator and the inhibitor.

Optionally, the mixed acid solution may further contain hydrofluoric acid and sulfuric acid.

The present invention also provides a method of manufacturing a semiconductor device, which includes:
using the method as defined above to establish a mathematical model of a reaction-diffusion system for chemical reactions involved in a wet etching process on a wafer surface;
using the mathematical model to simulate formation of dome-shaped micro-cavities formed on the wafer surface as a result of the wet etching process and thereby obtaining an optimal mixture ratio of a mixed acid solution used in the wet etching process; and
etching the wafer surface using the mixed acid solution with the optimal mixture ratio.

Optionally, the mixed acid solution with the optimal mixture ratio may be used to etch a substrate on the backside of the wafer to form morphologically optimal dome-shaped micro-cavities on a surface of the substrate, wherein the method further includes forming a metal electrode on the surface of the substrate.

Compared with the prior art, the present invention has the following benefits:
1. In the modeling method of the present invention, partial differential equations of a reaction-diffusion system for chemical reactions involved in a wet etching process which is performed on a wafer surface using a mixed acid solution are established. Each of the partial differential equations is the summation of a chemical reaction function and a spatial diffusion term. Formulas for the chemical reaction functions are obtained by applying the Brusselator model to the chemical reaction functions. The formulas for the chemical reaction functions are linearized and expanded, thereby determining conditions for developing a chemical clock for the chemical reactions in the wet etching process. Based on the conditions, simulation parameters of the formulas for the chemical reaction functions are calculated. Diffusion coefficients in the spatial diffusion terms, which allow formation of dome-shaped micro-cavities, are determined, thereby obtaining a mathematical model of the reaction-diffusion system for the chemical reactions involved in the wet etching process on the wafer surface. This mathematical model can be used to simulate the formation of dome-shaped micro-cavities formed on the wafer surface as a result of the wet etching process and thereby rapidly and accurately optimize a mixture ratio of the mixed acid solution used in the wet etching process.
2. In the method of manufacturing a semiconductor device, the modeling method is used to establish a mathematical model of a reaction-diffusion system for chemical reactions involved in a wet etching process on a wafer surface. The mathematical model is then used to simulate formation of dome-shaped micro-cavities formed on the wafer surface as a result of the wet etching process, thereby obtaining an optimal mixture ratio of a mixed acid solution used in the wet etching process. The mixed acid solution with the optimal mixture ratio is then used to etch the wafer surface. In this way, morphologically optimal dome-shaped micro-cavities can be formed on the wafer surface as a result of the etching process, which enable the semiconductor device being fabricated to have improved performance.

### BRIEF DESCRIPTION OF THE DRAWINGS

FIG. 1 is a flowchart of a method of modeling a wet etching process according to an embodiment of the present invention.

FIGS. 2 to 3 are scanning electron micrographs of wafer backsides that have undergone wet etching processes according to an embodiment of the present invention.

FIGS. 4 to 5 schematically illustrate simulated three-dimensional concentration profiles of product Y in wet etching processes according to an embodiment of the present invention.

FIG. 6 shows simulated variation of a concentration of product Y over a reaction time according to an embodiment of the present invention.

FIG. 7 shows a drain internal resistance profile of semiconductor devices that having undergone a wet etching process according to an embodiment of the present invention.

FIG. 8 is a schematic diagram showing the structure of a power MOSFET device according to an embodiment of the present invention.

### DETAILED DESCRIPTION

For example, when a wet etching process is carried out on a silicon substrate on the backside of a wafer using a mixed acid solution, dome-shaped cavities will be formed on a surface of the silicon substrate, which can increase a contact area with a metal electrode to be subsequently formed by metal sputtering and hence overall adhesion at the interface. Below, the formation of such dome-shaped cavities as a result of the wet etching process will be explained.

The wafer may be placed in an acid-containing tank or single wafer cleaning chamber of a cleaner so that the silicon surface on the backside of the wafer is processed. In the reaction stage, good control can be obtained over temperature, homogeneity of the mixed acids and liquid fluidity. In the above system, the reactants are transported in a main flow to a peripheral layer and then diffuse onto and react with the silicon surface. Moreover, products diffuse from the silicon surface into the peripheral layer and are then transported into the main flow.

At a given temperature, microscopic movement of molecules in the mixed acids greatly depends on a coefficient of viscosity of the mixed acids. That is, the greater a coefficient of viscosity the mixed acid solution has, the weaker the ability of solute molecules therein to diffuse. The mixed acid solution may contain nitric acid (HNO₃), hydrofluoric acid (HF), wafer and another viscosity modifier. Therefore, reactions between the mixed acids and the silicon substrate may involve oxidation of silicon (Si) and dissolution of silicon dioxide (SiO₂), the oxidation of silicon may be achieved by reduction of nitric acid and the dissolution of silicon dioxide may be achieved by etching with hydrofluoric acid. In general, these reactions are often expressed as:

$$Si + 4 {HNO}_{3} {\to }^{{k}_{f}} {SiO}_{2} + 4 {NO}_{2} ↑ + 2 {H}_{2} O \qquad ( 1 )$$

$${SiO}_{2} + 6 HF {\to }^{{k}_{d}} {H}_{2} {SiF}_{6} + 2 {H}_{2} O \qquad ( 2 )$$

where ↑ denotes a gaseous product, k_{f} represents a constant of the reaction that forms silicon dioxide, and k_{d} is a constant of the reaction that dissolves silicon dioxide.

As can be seen from Formulas (1) and (2), the chemical reactions take place at a solid-liquid interface and give rise to a gaseous product. This reaction system is a typical heterogeneous system. The formation rate, size and stay time at the silicon surface of bubbles are key parameters that affect a feature size of resulting dome-shaped cavities. Of course, the rates of the reactions are affected by ambient temperature, flow field distribution and other physical parameters.

According to the present invention, dome-shaped cavities are formed as a result of the reactions because the gaseous product arising from reactions between silicon and nitric acid will form bubbles in the solution after its saturation therein, which lead to local changes in concentration profiles of the products in the solution. Escape of the gaseous product from the liquid phase facilitates forward progress of the chemical reaction (1). The solid silicon can be considered as constant in the reaction, while nitric acid maintains a concentration gradient from the main flow external to the peripheral layer to the reaction interface, which enables its continuous diffusion toward the interface. Moreover, the bubbles tend to drift upward under the action of buoyancy, and under the effect of the continuity of the liquid flow, the same volumes of the fluid that carries the reactants will be drawn under the bubbles. These actions together accelerate the formation of dome-shaped voids in the same shape as the bubbles.

At an early stage of the chemical reactions, only small, independent bubbles are generated at locations where the reactions happen, therefore a flow-reaction action prevails. As the reactions progress, the bubbles “grow” in size, leading to increasingly smaller inter-bubble distances and giving rise to a mask effect. As a result, the flow-reaction action decays, and a diffusion-reaction action grows. The rate of upward movement of bubbles in the liquid can be controlled by introducing a viscosity modifier. Thus, a desired size of the final dome-shaped cavities can be achieved by a comprehensive consideration of the above factors.

As noted above, due to high complexity of the reactions between the mixed acid solution and the substrate, which result in the formation of the dome-shaped cavities, it seems impossible to identify the best mixture ratio of the mixed acids through experimental design. In order to overcome this, the present invention proposes a method of modeling a wet etching process and a method of manufacturing a semiconductor device, which can rapidly and accurately identify an optimal mixture ratio for mixed acids and thus form dome-shaped cavities with optimized morphology on a surface of a substrate on the backside of a wafer.

In order that objects, advantages and features of the present invention become more apparent, the methods proposed herein will be described in greater detail. Note that the accompanying drawings are provided in a very simplified form not necessarily drawn to exact scale for the only purpose of facilitating easy and clear description of the disclosed embodiments.

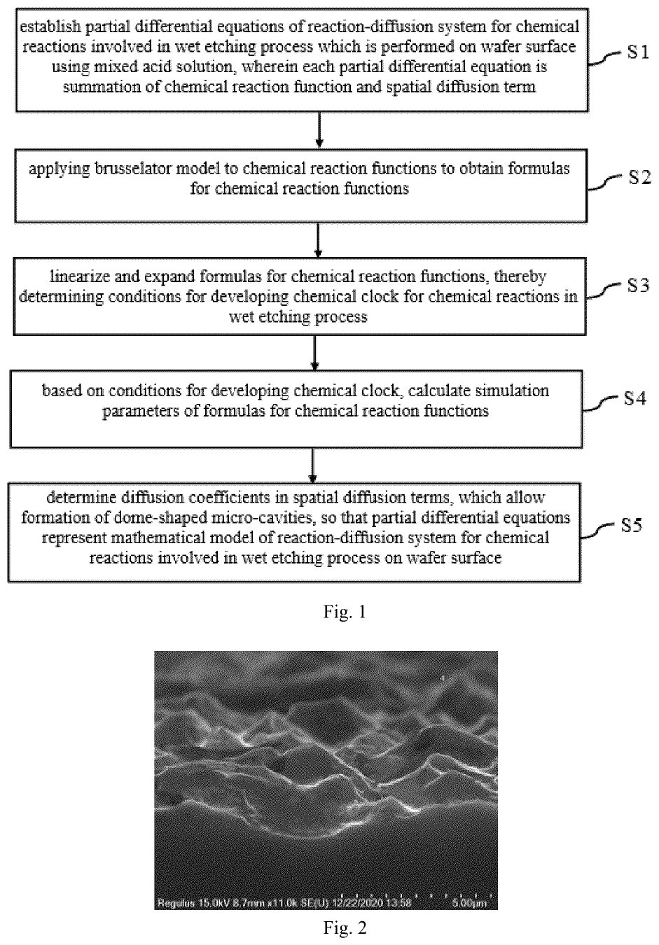

In embodiments of the present invention, there is proposed a method of modeling a wet etching process. FIG. 1 is a flow diagram of a method of modeling a wet etching process according to an embodiment of the present invention. As shown, the method of modeling a wet etching process includes the steps as follows:
Step S1: Establish partial differential equations of a reaction-diffusion system for chemical reactions involved in the wet etching process which is performed on a wafer surface using a mixed acid solution. Each partial differential equation is the summation of a chemical reaction function and a spatial diffusion term.
Step S2: Obtain formulas for the chemical reaction functions by applying the Brusselator model to the chemical reaction functions.
Step S3: Linearize and expand the formulas for the chemical reaction functions and thereby determine conditions for developing a chemical clock for the chemical reactions involved in the wet etching process.
Step S4: Based on the conditions, calculate simulation parameters of the formulas for the chemical reaction functions.
Step S5: Determine diffusion coefficients in the spatial diffusion terms, which allow the formation of dome-shaped micro-cavities, so that the partial differential equations represent a mathematical model of the reaction-diffusion system for the chemical reactions involved in the wet etching process on the wafer surface.

A more detailed process of modeling a wet etching process according to this embodiment will be explained below.

In step S1, partial differential equations of a reaction-diffusion system for chemical reactions involved in the wet etching process which is performed on a wafer surface using a mixed acid solution are established. Each partial differential equation is the summation of a chemical reaction function and a spatial diffusion term. That is, it takes into account contributions of both the chemical reaction and diffusion.

The wafer may include a substrate and a layered structure on the substrate. The substrate may be any suitable substrate well known to those skilled in the art, such as silicon (Si), germanium (Ge), silicon germanium (SiGe), silicon carbide (SiC), silicon germanium carbide (SiGeC), silicon-on-insulator (SOI), etc. The layered structure may be, for example, a gate structure, a dielectric layer or the like. The gate structure may be a polysilicon gate or a metal gate. The dielectric layer may consist of at least one of silicon oxide, silicon oxynitride or silicon oxycarbide. It is to be noted that the present invention is not limited to any particular structure of the wafer, and any suitable wafer may be chosen according to the intended device to be fabricated.

The mixed acid solution may contain nitric acid, hydrofluoric acid, wafer and another viscosity modifier. The viscosity modifier is inert carrier and may be chosen as sulfuric acid. It is to be noted that the present invention is not limited to any particular material of the wafer surface to be treated with the wet etching process or any particular composition of the mixed acid solution, and a suitable mixed acid solution may be chosen for the material of the wafer surface to be treated with the wet etching process. Additionally, the wet etching process may be performed on either the front side of the wafer (e.g., for forming a gate structure by etching polysilicon) or the substrate (e.g., silicon) on the backside of the wafer. That is to say, the present invention is suitable for use in any application requiring the formation of dome-shaped micro-cavities on a wafer surface as a result of an optimized wet etching process using a mixed acid solution, which allow a larger contact area with a subsequently-formed structure and hence enhanced overall adhesion at the interface.

The wet etching process, which is performed on the wafer surface using the mixed acid solution, involves complex chemical reactions, and there is a reaction-diffusion system for the chemical reactions. In the reaction-diffusion system, a stable state will lose its stability under a certain condition and spontaneously generate a spatially stable pattern, i.e., a so-called Turing pattern. The generation of the Turing pattern corresponds to the coupling of a nonlinear dynamic reaction process with a diffusion process. Therefore, resorting to mathematical modeling, partial differential equations of the reaction-diffusion system can be established for the complex chemical reactions to explore and elucidate their mechanisms. The partial differential equations may be as follows:

$$\frac{\partial X}{\partial t} = {f}_{X} ( X , Y ) + {D}_{X} {∇}^{2} X \qquad ( 3 )$$

$$\frac{\partial Y}{\partial t} = {f}_{Y} ( X , Y ) + {D}_{Y} {∇}^{2} Y \qquad ( 4 )$$

where ƒ_{X}(X, Y) and ƒ_{Y}(X, Y) are chemical reaction functions, D_{X}∇²X and D_{Y}∇²Y are spatial diffusion terms, D_{X} and D_{Y} are diffusion coefficients of an activator and an inhibitor, respectively, ∇² is the Laplace operator, and X and Y are concentrations of the activator and the inhibitor, respectively.

In step S2, formulas for the chemical reaction functions are obtained by applying the Brusselator model to the chemical reaction functions.

The Brusselator model is a theoretical model proposed by I. Prigogine and his collaborators at the Université Libre de Bruxelles for self-organizing phenomena such as chemical clocks. The Brusselator model is used to describe chemical reactions like the following set:

$$A {\to }^{{k}_{1}} X \qquad ( 5 )$$

$$B + X {\to }^{{k}_{2}} Y + D \qquad ( 6 )$$

$$2 X + Y {\to }^{{k}_{3}} 3 X \qquad ( 7 )$$

$$X {\to }^{{k}_{4}} E \qquad ( 8 )$$

where A and B are initial concentrations of reactants, D and E are concentrations of products, k₁, k₂, k₃ and k₄ are reaction constants, and X and Y are concentrations of an activator and an inhibitor.

According to these dynamic reaction equations (5) through (8) in the Brusselator model, formulas for the chemical reaction functions in the partial differential equations may be developed as:

$${f}_{X} ( X , Y ) = {k}_{1} A - ( {k}_{2} B + {k}_{4} ) X + {k}_{3} {X}^{2} Y \qquad ( 9 )$$

$${f}_{Y} ( X , Y ) = {k}_{2} BX - {k}_{3} {X}^{2} Y \qquad ( 10 )$$

When the mixed acid solution contains nitric acid, hydrofluoric acid and sulfuric acid, and in case of the wafer surface being silicon, the wet etching process on the wafer surface using the mixed acid solution will involve heterogeneous reactions, which oxidize the silicon surface and dissolve silicon dioxide. The oxidation of silicon is achieved by reduction by nitric acid, and the dissolution of silicon dioxide is achieved by etching by hydrofluoric acid. Sulfuric acid is added to adjust the viscosity of the mixed acid solution. Since dissolution of silicon dioxide by hydrofluoric acid occurs at a higher rate than reactions between nitric acid and silicon, the latter reaction determines the morphology of the wafer surface after the etching process is complete. The mechanisms of reactions between nitric acid and silicon are discussed below.

In the reaction system, nitrogen in the oxidant nitric acid is positive pentavalent and can be reduced to its positive monovalent (N+), bivalent (N₂₊), trivalent (N₃₊) and tetravalent (N⁴⁺) states, corresponding to the products nitrous oxide (N₂O), nitric oxide (NO), dinitrogen trioxide (N₂O₃) and nitrogen dioxide (NO₂), respectively, which exhibits different solubility and stability in the solution. Accordingly, the following chemical reactions may occur between nitric acid and silicon:

$${HNO}_{3} + {H}^{+} {{⇌}_{{k}_{- 5}}}^{{k}_{5}} {NO}_{2}^{+} + {H}_{2} O \qquad ( 11 )$$

$${NO}_{2}^{+} + {e}^{-} {{⇌}_{{k}_{- 6}}}^{{k}_{6}} {NO}_{2} \qquad ( 12 )$$

$${NO}_{2} + {H}_{3}^{+} O {{⇌}_{{k}_{- 7}}}^{{k}_{7}} {HNO}_{2} + {H}_{2} O \qquad ( 13 )$$

$${HNO}_{3} + 2 NO + {H}_{2} O {\to }^{{k}_{8}} 3 {HNO}_{2} \qquad ( 14 )$$

$$2 {HNO}_{2} + Si {\to }^{{k}_{9}} {SiO}_{2} + {N}_{2} O + {H}_{2} O \qquad ( 15 )$$

$${N}_{2} O + 4 {NO}_{2} + 3 {H}_{2} O {\to }^{{k}_{10}} 6 {HNO}_{2} \qquad ( 16 )$$

where k₅, k₋₅, k₆, k₋₆, k₇, k₋₇, k₈, k₉ and k₁₀ are reaction constants. Since the reactions of Eqns. (11) to (13) are reversible, k₅ [symbol] k₋₅ [symbol] k₆ [symbol] k₋₆ [symbol] k₇ and k₋₇ are equilibrium constants of these reactions when they are in equilibrium. According to the Brusselator model, HNO₂ is identified as an activator and N₂O as an inhibitor.

Thus, an activator-inhibitor reaction mechanism is proposed herein for the heterogeneous reaction system for oxidation of the silicon surface and dissolution of silicon dioxide, in which HNO₂ is taken as an activator, and bubbles of N₂O (where N⁺ is the lowest positive valence), which is one of the products, as an inhibitor. Dome-shaped cavities can be formed on the wafer surface as a result of the reactions between nitric acid and silicon. Specifically, at the beginning, silicon on the surface reacts with HNO₂ to produce N₂O molecules, N₂O molecules accumulate in the solution until a gas-liquid equilibrium is reached. Thereafter, additional N₂O will form bubbles in the oversaturated solution. Bubbles grow in size at locations where the reactions take place, and some adjacent bubbles may merge to form new bubbles. Under the action of buoyancy, the N₂O bubbles tend to move upward, leaving voids thereunder. Due to spatial continuity of flow, the surrounding liquid will be drawn under the bubbles and fill the voids left by them. As can be seen from the following equation, the added high-viscosity liquid sulfuric acid (with a viscosity of μₗ) significantly slows down the upward movement of the bubbles, while the reactions continue thereunder due to the reactants are being supplied at high concentrations by the liquid flow. As the bubbles further grow in size, they will completely detach from the silicon surface at a time point when the buoyancy overcomes the resistance, leaving geometrically identical dome-shaped cavities on the silicon surface.

$${u}_{T} = \frac{1}{18} \times \frac{{gd}_{e}^{2} ( {ρ}_{l} - {ρ}_{g} )}{{μ}_{l}}$$

where g represents the gravitational acceleration, dₑ is a diameter of equivalent spheres of N₂O bubbles, μₗ is the dynamic viscosity of the solution, and ρₗ and ρ_{g} are the mass densities of the solution and the bubbles.

When the reaction of Eqn. (13) reaches an equilibrium, the equilibrium constant k₇ satisfies

$${k}_{7} = \frac{[ {HNO}_{2} ]}{[ {NO}_{2} ]} = \frac{{C}_{{HNO}_{2}}}{{C}_{{NO}_{2}}} = \frac{X}{{C}_{{NO}_{2}}} \qquad ( 17 )$$

Thus, according to Eqns. (11) to (16) of the reactions between nitric acid and silicon, through applying the Brusselator model to the chemical reaction functions, the formulas for the chemical reaction function may be obtained as:

$${f}_{X} ( X , Y ) = {k}_{8} {C}_{{HNO}_{3}} {C}_{NO}^{2} + {k}_{7} {C}_{{NO}_{2}} - {k}_{- 7} X - {k}_{9} {X}^{2} + \frac{{k}_{10}}{{k}_{7}^{4}} {X}^{4} Y \qquad ( 18 )$$

$${f}_{Y} ( X , Y ) = {k}_{9} {X}^{2} - \frac{{k}_{10}}{{k}_{7}^{4}} {X}^{4} Y \qquad ( 19 )$$

where C_{HNO}_{₃} [symbol] C_{NO} [symbol] C_{NO}_{₂}, C_{HNO}_{₃} [symbol] C_{NO} [symbol] C_{NO}_{₂}, C_{HNO}_{₃} [symbol] C_{NO} [symbol] C_{NO}_{₂} and C_{HNO}_{₂} are molar concentrations of HNO₃, NO, NO₂ and HNO₂, respectively, in an equilibrium of the reactions of Eqns. (13) to (16).

In step S3, the formulas for the chemical reaction functions are linearized and expanded to determine conditions for developing a chemical clock for the chemical reactions involved in the wet etching process. Such chemical clocks are necessary for the formation of periodic microstructures (i.e., dome-shaped micro-cavities) on the wafer surface using the wet etching process. The conditions may be determined using the following process.

At first, reaction coefficients in the formulas are normalized to simplify the formulas.

Specifically, let

$$A = \frac{{k}_{- 7}}{{k}_{9}} \qquad ( 20 )$$

$$B = \frac{{k}_{10}}{{k}_{7}^{4} {k}_{9}} \qquad ( 21 )$$

$$C = \frac{{C}_{{HNO}_{2}}}{{k}_{9}} \qquad ( 22 )$$

Moreover, since the mixed acid solution is constantly replenished in the process, C_{HNO}_{₂} can be considered as a constant and therefore C_{HNO}_{₂} satisfies:

$${C}_{{HNO}_{2}} = {k}_{8} {C}_{{HNO}_{3}} {C}_{NO}^{2} + {k}_{7} {C}_{{NO}_{2}} \qquad ( 23 )$$

Substituting Eqns. (20) to (23) in Eqns. (18) to (19) satisfies the formulas for the chemical reaction functions as

$${f}_{X} ( X , Y ) = C - AX - {X}^{2} + {BX}^{4} Y \qquad ( 24 )$$

$${f}_{Y} ( X , Y ) = {X}^{2} - {BX}^{4} Y \qquad ( 25 )$$

where A, B and C are parameters corresponding to the normalized reaction constants and diffusion coefficients and also simulation parameters of the formulas and mathematical models for the chemical reaction functions. Eqns. (24) to (25) are nonlinear equations, and their solutions X(t) and Y(t) represent concentrations of the activator X and the inhibitor Y at time t, respectively. Depending on the parameter combination [A,B,C], the solutions X(t) and Y(t) of the nonlinear equations may be constant at a certain value, continuously diverge, or vary periodically (i.e., chemical clocks). These chemical clocks enable the formation of periodic microstructures (i.e., dome-shaped micro-cavities) on the wafer surface using the wet etching process.

Subsequently, the simplified formulas for the chemical reaction functions, i.e., Eqns. (24) to (25), are linearized and expanded, further simplifying them into:

$${f}_{X} ( X , Y ) = aX + bY \qquad ( 26 )$$

$${f}_{Y} ( X , Y ) = cX + dY \qquad ( 27 )$$

Next, let the linearized and expanded formulas satisfy at a pole (X₀, Y₀):

$${f}_{X} ( {X}_{0} , {Y}_{0} ) = 0 \qquad ( 28 )$$

$${f}_{Y} ( {X}_{0} , {Y}_{0} ) = 0 \qquad ( 29 )$$

where

$$[ \begin{matrix}a & b \\ c & d\end{matrix} ]$$

represents the Jacobian matrix

$$[ \begin{matrix}\frac{\partial {f}_{X}}{\partial X} & \frac{\partial {f}_{X}}{\partial Y} \\ \frac{\partial {f}_{Y}}{\partial X} & \frac{\partial {f}_{Y}}{\partial Y}\end{matrix} ]$$

of the Eqns. (24) to (25) at the poles (X₀, Y₀).

Thus, according to the nonlinear system theory, when the following conditions are satisfied, the system will have a limit cycle around the pole (X₀, Y₀), and these conditions are taken as those for developing a chemical clock for the chemical reaction:

$$a + d = 0 \qquad ( 30 )$$

$$ad - bc > 0 \qquad ( 31 )$$

In step S4, based on the conditions for developing a chemical clock simulation parameters of the formulas for the chemical reaction functions are calculated using the following process.

First of all, an amount of the etched-away material of the wafer surface, which is silicon, for example, is measured.

After that, based on the measurement, ranges of the reaction constants such as reaction rate constants are estimated, for example, as 10⁻³ mol/(L·s)-10⁻⁴ mol/(L·s).

Specific values of the reaction constants are then calculated based on the estimated ranges according to the equations satisfied at the pole (i.e., Eqns. (28) to (29)) and the conditions for obtaining a limit cycle around the pole (i.e., near the pole) (i.e., Eqns. (30) to (31)). Table 1 summarizes such specific values of the reaction rate constants for developing a chemical clock.

TABLE 1

| | | |
|---|---|---|
| k₋₇ | 3.10 × 10⁻³ | mol/(L · s) |
| k₉ | 2.07 × 10⁻³ | mol/(L · s) |
| K₁₀/k₇⁴ | 2.37 × 10⁻⁴ | mol/(L · s) |
| C_{HNO}_{₂} | 6.42 × 10⁻³ | mol/L |

Subsequently, from the calculated reaction constants, simulation parameters of the formulas for the chemical reaction functions are computed by normalizing the reaction coefficients in the formulas. Specifically, the specific values of the reaction rate constants listed in Table 1 may be substituted into Eqns. (20) to (22), thereby obtaining values of the normalized parameters (i.e., simulation parameters) A, B, C for developing a chemical clock, as shown in Table 2.

TABLE 2

| Simulated Parameter | Value |
|---|---|
| A | 1.50 |
| B | 0.1144 |
| C | 3.10 |

In step S5, diffusion coefficients in the spatial diffusion terms, which allow the formation of dome-shaped micro-cavities, are determined so that the partial differential equations that have undergone a series of linearization and expansion operations represent a mathematical model of the reaction-diffusion system for the chemical reactions involved in the wet etching process on the wafer surface.

For an ideal mixed acid solution, the diffusion coefficients (D_{X} and D_{Y}) in the spatial diffusion terms may be represented by the Stokes-Einstein equation. Theoretical estimates of the diffusion coefficients of the activator and the inhibitor at two sulfuric acid concentrations in the mixed acid solution (75% and 80% by weight) are listed in Table 3. From this table, it can be seen that the activator and the inhibitor have lower theoretical diffusion coefficient estimates at a higher concentration of the viscosity modifier (sulfuric acid).

TABLE 3

| Theoretical Estimate | H₂SO₄ 75% | H₂SO₄ 80% |
|---|---|---|
| D_{X}(μm²/s) | 10.9 | 8.8 |
| D_{Y}(μm²/s) | 94.8 | 76.4 |

Diffusion coefficient values calculated according to the Stokes-Einstein equation at high concentrations of the mixed acid solution would greatly deviate from the actual values. In order to overcome this, for an actual scan electron microscopy (SEM) image, the closest simulated image may be obtained using an iterative method to identify an optimal set of diffusion coefficients, which is closer to the actual values.

Accordingly, the diffusion coefficients in the spatial diffusion terms, which allow the formation of dome-shaped micro-cavities, may be determined by simulation using the following process. With the calculated reaction constants being kept at constant values (i.e., the specific values of the reaction rate constants in Table 1), diffusion coefficient values of the activator and the inhibitor are estimated from an actual viscosity measurement of the mixed acid solution as initial values, and a simulation process is performed using a difference iteration approach such that the activator and the inhibitor exhibit spatially periodic concentration profiles. In this way, the diffusion coefficients of the activator and the inhibitor can be determined. As can be seen from Table 4, a higher concentration of the viscosity modifier (sulfuric acid) in the mixed acid solution leads to lower diffusion coefficients of the activator and the inhibitor in the solution.

TABLE 4

| Simulation | H₂SO₄ 75% | H₂SO₄ 80% |
|---|---|---|
| D_{X}(μm²/s) | 5.8 | 2.5 |
| D_{Y}(μm²/s) | 58 | 25 |

The diffusion coefficients in Tables 3 and 4 are measured in μm²/s because the sizes of bubbles and simulated spaces are on the order of microns.

Thus, now that the diffusion coefficients D_{X} and D_{Y} in the spatial diffusion terms, which allow the formation of dome-shaped micro-cavities have been determined in step S5, and the simulation parameters A, B, C of the formulas for the chemical reaction functions have been determined in step S4, a mathematical model of the reaction-diffusion system for the chemical reactions involved in the wet etching process on the wafer surface can be obtained by summing the formulas for the chemical reaction functions (Eqns. (24) to (25)) and the spatial diffusion terms as:

$${f}_{X} ( X , Y ) = C - AX - {X}^{2} + {BX}^{4} Y + {D}_{X} {∇}^{2} X \qquad ( 32 )$$

$${f}_{Y} ( X , Y ) = {X}^{2} - {BX}^{4} Y + {D}_{Y} {∇}^{2} Y \qquad ( 33 )$$

Eqns. (32) to (33) can be solved by numerical calculation X and Y can be represented by 100 μm*100 μm matrices. Elements in X are all random numbers with initial values in [0,1], which describe initial values of the activator HNO₂ in the actual chemical reaction and its uneven distribution. Initial values of elements in Y are all set to 0. Moreover, the Laplace operator ∇² as a cyclic convolution, and the differential equations are solved using Euler's method.

Using the established mathematical model, dome-shaped micro-cavities formed on the wafer surface as a result of the wet etching process can be simulated, and the mixture ratio of the mixed acid solution used in the wet etching process can be optimized to achieve a desired morphology of the dome-shaped micro-cavities. The optimized mixture ratio of the mixed acid solution can be then applied to the wet etching process on the wafer surface.

Further, in order to verify the effectiveness of the mathematical model of the reaction-diffusion system for the chemical reactions involved in the wet etching process on the wafer surface, experiments were designed, in which, with the temperature being kept constant in the wet etching process, and a weight percentage of high-viscosity sulfuric acid, which was added to the mixed acid solution to increase its viscosity, was varied to control the size of bubbles formed in the chemical reactions. Reference is now made to Table 5. As can be seen from Table 5, although actual viscosity measurements were slightly higher than theoretically calculated viscosity values which were obtained based on diluted systems, these two types of viscosity values showed the same trend—the greater the weight percentage of sulfuric acid in the mixed acid solution, the higher the viscosity of the mixed acid solution and hence the lower the diffusion coefficients of the components in the solution. Simulations were performed over the same periods as the actual experiments.

TABLE 5

| | Viscosity of | Weight Percentage of Sulfuric Acid | | | |
|---|---|---|---|---|---|
| Component | Component (cp) | (H₂SO₄) in Mixed Acid Solution (%) | | | |
| H₂O | 0.89 | 9.5% | 12.0% | 14.5% | 17.0% |
| HNO₃ | 1.2 | 7.5% | 7.5% | 7.5% | 7.5% |
| HF | 0.89 | 3.0% | 3.0% | 3.0% | 3.0% |
| H₂SO₄ | 23.8 | 80.0% | 77.5% | 75.0% | 72.5% |

| | | | | |
|---|---|---|---|---|
| Calculated Viscosity (cp) | 8.95 | 8.02 | 7.21 | 6.51 |
| Actual Viscosity Measurement (cp) | 17.2 | 15.76 | 15.37 | 15.08 |
| Estimated H⁺ Diffusion | 166.0 | 181.0 | 186.0 | 189.0 |
| Coefficient (μm²/s) | | | | |
| Estimated F⁻ Diffusion | 96.4 | 105.0 | 108.0 | 110.0 |
| Coefficient (μm²/s) | | | | |
| Estimated NO₃⁻ Diffusion | 69.0 | 75.3 | 77.3 | 78.7 |
| Coefficient (μm²/s) | | | | |

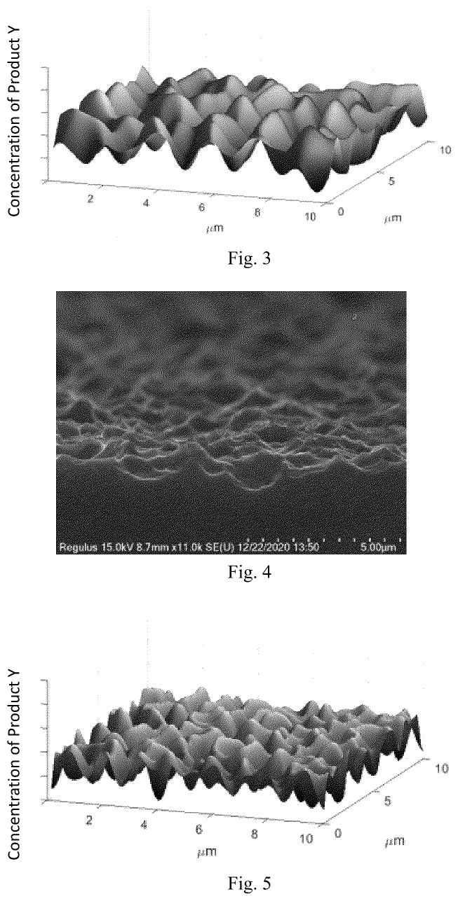

Reference is further made to FIGS. 2 to 3 and 4 to 5. FIGS. 2 and 4 are scanning electron micrographs of the backside of a wafer having undergoing wet etching processes using mixed acid solutions containing sulfuric acid at weight percentages of 75% and 80%. FIGS. 3 and 5 schematically illustrate simulated three-dimensional concentration profiles of product Y (i.e., the inhibitor N₂O) produced in wet etching processes using mixed acid solutions containing sulfuric acid at weight percentages of 75% and 80%. As can be seen from FIGS. 2 and 4, at the same given test magnification, a higher sulfuric acid concentration of the mixed acid solution leads to the formation of smaller and denser dome-shaped micro-cavities on the wafer surface.

The product (N₂O molecules) diffuses slower at a higher viscosity of the mixed acid solution. As a result, collision and aggregation of molecules occur at lower rates, leading to slower growth of bubbles. Over the same reaction time, N₂O bubbles formed in a mixed acid solution with a higher viscosity have a smaller size/diameter, compared with those formed in a mixed acid solution with a lower viscosity. Moreover, at the same number of bubbles per unit area, the smaller bubbles are more likely to coalesce during random movement.

Further, the concentration profiles of the product N₂O after the convergence of the reaction-diffusion systems at the diffusion coefficients corresponding to the two different sulfuric acid concentrations shown in Table 4 presents different characteristics as shown in FIGS. 3 and 5. As can be seen from the simulation results of FIGS. 3 and 5, the concentration profiles of the product N₂O also have dome-shaped cavities, and the dome-shaped micro-cavities at the higher sulfuric acid concentration of the mixed acid solution are smaller and denser. This is consistent with the observation in the scanning electron micrographs of FIGS. 2 and 4. The reactants move to the bottom of the cavities by capillary flow and diffusion, and the product tends to move to the top by diffusion. As a result of these two actions, the product rapidly concentrates at the bottom of the cavities and its concentration rapidly exceeds a saturation level. This causes the product N₂O to diffuse into the bubbles, leading to a decrease in its concentration under the bubbles.

In the simulations, since the diffusion terms correspond to spatial axes, the concentration profiles of the product are also a direct reflection of physical morphologies at the interfaces. Moreover, the smaller the diffusion coefficients, the smaller and denser the dome-shaped cavities. As can be seen from the simulation results in Table 6, the higher the sulfuric acid concentration of the mixed acid solution, the smaller the feature size of the dome-shaped micro-cavities, which is the same as seen in actual measurements.

TABLE 6

| Simulation | H₂SO₄ 75% | H₂SO₄ 80% |
|---|---|---|
| Average Size of Microstructures (μm) | 1.40 | 0.97 |
| Standard Deviation (μm) | 0.12 | 0.06 |

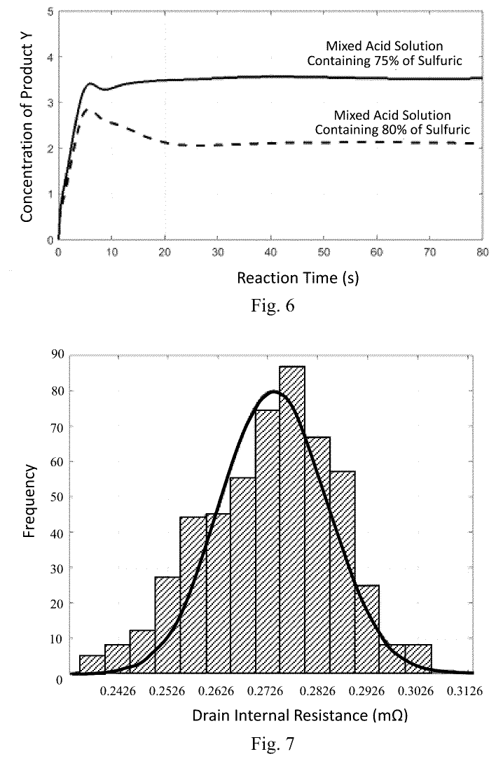

FIG. 6 shows simulated variation of a concentration of the product N₂O at a given spatial location over a reaction time at weight percentages of 75% and 80% of sulfuric acid in the mixed acid solution, which characterizes a dynamic reaction process. As can be seen from FIG. 6, the reactions become increasingly stable at around 30 s and completely stable after 50 s. The total reaction time is 60 s. The system's reaction rate predicted by this simulation model is supported by actual experimental results.

In an example, a wet etching process was carried out prior to the formation of a film by physical sputtering on the backside of a trench-isolated device being fabricated. The wet etching process was performed at a temperature of 25-35° C. using a mixed acid solution consisting of H₂O, HNO₃ (70%), HF (49%) and H₂SO₄ (96%) at a mixture ratio which has been optimized with the mathematical model so that weight percentages of the components are in the ranges of 10-15%, 7-9%, 3-5% and 75-80%, respectively, to form a back electrode on the backside of the device being fabricated. A key parameter of the back electrode of the trench-isolated device (drain internal resistance) was tested. FIG. 7 shows a drain internal resistance profile of trench-isolated devices that have undergone the wet etching process. FIG. 7 shows statistics of the test results of 525 wafers. As shown, the drain internal resistance values were concentrated around an average of 0.275 mΩ (3σ=0.04 mΩ), suggesting that the drain internal resistance resulting from the mixture ratio of the mixed acid solution that has been optimized with the mathematical model is successfully controlled within a desired range of this electrical parameter and the process has good stability.

Thus, the effectiveness of the mathematical model of the reaction-diffusion system for the chemical reactions involved in the wet etching process on the wafer surface has been validated. The simulation results were consistent with the actual measurements. The feasibility and accuracy of the established mathematical model have been confirmed. Stable electrical parameter can be achieved in practical applications, suggesting its high value of practical application.

In summary, according to the present invention, the Brusselator model is introduced to the modeling of a complex reaction-diffusion mechanism involved in a wet etching process and coupled with chemical reaction mechanisms and microscopic (micron-scale) characteristics appearance of the products in the wet etching process to develop a model represented by differential and integral equations, which can quantitatively describe the dynamic reaction-diffusion process, and determine formulas for chemical reaction functions and spatial diffusion terms, which affect the formation of dome-shaped micro-cavities on a wafer surface. In this way, a mathematical model of the reaction-diffusion system for chemical reactions involved in the wet etching process on the wafer surface can be obtained, which can be used to simulate the formation of dome-shaped micro-cavities on the wafer surface as a result of the wet etching process and thereby optimize a mixture ratio of a mixed acid solution used in the wet etching process. In this way, an optimal mixture ratio can be rapidly and accurately determined for the mixed acid solution.

In an embodiment of the present invention, there is also provided a method of manufacturing a semiconductor device, which includes the steps as follows.

First of all, a mathematical model of a reaction-diffusion system for chemical reactions involved in a wet etching process performed on a wafer surface is established using the method as discussed above. Reference can be made to the above description for details of the above method, and further description thereof is omitted herein for the sake of brevity.

Next, the mathematical model is used to simulate the formation of dome-shaped micro-cavities on the wafer surface as a result of the wet etching process to optimize a mixture ratio of a mixed acid solution used in the wet etching and thereby obtain an optimal mixture ratio for the mixed acid solution used in the wet etching process.

Subsequently, the wafer surface is etched with the mixed acid solution with the optimal mixture ratio so that morphologically optimal dome-shaped micro-cavities are formed on the wafer surface as a result of the etching. Here, by “morphologically optimal”, it is intended to mean that the dome-shaped micro-cavities has a size and density as required by a device being fabricated, which enable the device to have improved performance.

The mixed acid solution with the optimal mixture ratio may be used to etch a substrate on the backside of the wafer to form morphologically optimal dome-shaped micro-cavities on a surface of the substrate on the backside of the wafer.

The method may further include forming a metal electrode on the surface of the substrate on the backside of the wafer. The morphologically optimal dome-shaped micro-cavities formed on the surface of the substrate on the backside of the wafer enable increased adhesion of the metal electrode to the substrate on the backside of the wafer, which results in improved performance of the semiconductor device being fabricated. For example, the trench-isolated device of FIG. 7 has drain internal resistance controlled within a desired range of this electrical parameter, and the process has good stability.

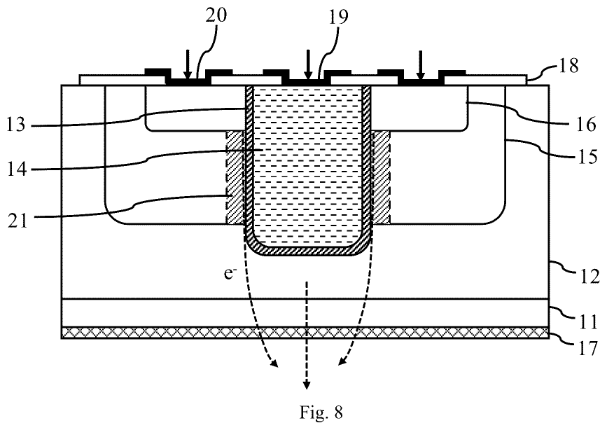

For example, the device being fabricated may be a vertical power MOSFET device as shown in FIG. 8, which includes: an n-type epitaxial layer 12 (i.e., a drift region) formed on a heavily doped n-type substrate 11; a trench (not shown) formed in the epitaxial layer 12; a gate oxide layer 13 formed over inner walls of the trench; a polysilicon gate 14 filled in the trench to alleviate electric field concentration under the polysilicon gate 14; a lightly doped region p-type 15 formed in the epitaxial layer 12 on opposing sides of the trench so that a bottom surface of the trench is lower than a bottom surface of the lightly doped region 15; a (heavily doped n-type) source region 16 on top of the lightly doped region 15 on opposing sides of the trench; a depletion layer 21 provided by a portion of the lightly doped region 15 proximate the trench under the source region 16; a (heavily doped n-type) drain region 17 formed at the bottom of the substrate 11 (i.e., on the backside of the substrate 11); a field oxide layer 18 formed on a top surface of the epitaxial layer 12; openings (not shown) in the field oxide layer 18, which respectively expose portions of top surfaces of the source region 16 and the polysilicon gate 14; a gate contact electrode 19 in contact with the polysilicon gate 14 and a source contact electrode 20 in contact with the source region 16, which are respectively formed in the openings.

In operation of the power MOSFET device shown in FIG. 8, a forward voltage (e.g., 10 V) is applied between the polysilicon gate 14 and the source region 16, creating an electric field which attracts minority carriers (i.e., electrons) from the lightly doped region 15 a surface under the polysilicon gate 14, as indicated by the dotted arrow in FIG. 8. As the forward bias voltage between the polysilicon gate 14 and the source region 16 increases, more electrons are attracted to said region, leading to an electron density higher than a hole density there and hence conductivity-type inversion of the lightly doped region 15 on opposing sides of the polysilicon gate 14 from p-type to n-type. As a result, it becomes an n-type “channel”, allowing an electric current to directly flow through the n+ drain region 17, the n-region and the n-channel under the polysilicon gate 14 to the n+ source region 16.

A length of the drift region between the source region 16 and the drain region 17 is controlled by a thinning process performed on the backside of the device. Following the thinning process, a metal electrode (not shown, for the application thereto of a positive voltage, for example, of 30 V) is formed by metal sputtering on the backside of the device. The backside thinning process may include a wet etching step as a critical step, in which a mixed acid solution with a mixture ratio that has been optimized using the above-discussed mathematical model established in accordance with the present invention may be used to etch the backside of the device. In this way, as a result of the etching process, morphologically optimal dome-shaped micro-cavities can be formed on the backside of the device, which enable increased adhesion of the metal electrode to the substrate on the backside of the device and hence improved performance of the device being fabricated.

In summary, in a wet etching process, through etching a wafer surface with a mixed acid solution having a mixture ratio that has been optimized using a mathematical model of a reaction-diffusion system established by the above-discussed inventive modeling method for chemical reactions involved in the wet etching process, morphologically optimal dome-shaped micro-cavities can be formed on the wafer surface, which enable a semiconductor device being fabricated to have enhanced performance.

The description presented above is merely that of a few preferred embodiments of the present invention and is not intended to limit the scope thereof in any sense. Any and all changes and modifications made by those of ordinary skill in the art based on the above teachings fall within the scope as defined in the appended claims.

1. A method of modeling a wet etching process, comprising:
establishing partial differential equations of a reaction-diffusion system for chemical reactions involved in the wet etching process which is performed on a wafer surface using a mixed acid solution, wherein each of the partial differential equations is the summation of a chemical reaction function and a spatial diffusion term;
applying the Brusselator model to the chemical reaction functions to obtain formulas for the chemical reaction functions;
linearizing and expanding the formulas for the chemical reaction functions and thereby determining conditions for developing a chemical clock for the chemical reactions in the wet etching process;
based on the conditions for developing a chemical clock, calculating simulation parameters of the formulas for the chemical reaction functions; and
determining diffusion coefficients in the spatial diffusion terms, which allow formation of dome-shaped micro-cavities, so that the partial differential equations represent a mathematical model of the reaction-diffusion system for the chemical reactions involved in the wet etching process on the wafer surface.

2. The method of modeling a wet etching process of claim 1, wherein the partial differential equations are
$$\frac{\partial X}{\partial t} = {f}_{X} ( X , Y ) + {D}_{X} {∇}^{2} X$$
$$\frac{\partial Y}{\partial t} = {f}_{Y} ( X , Y ) + {D}_{Y} {∇}^{2} Y$$
where ƒ_{X} (X, Y) and ƒ_{Y}(X, Y) are the chemical reaction functions, D_{X}∇²X and D_{Y}∇²Y are the spatial diffusion terms, D_{X} and D_{Y} are diffusion coefficients of an activator and an inhibitor, respectively, ∇² is the Laplace operator, and X and Y are concentrations of the activator and the inhibitor, respectively.

3. The method of modeling a wet etching process of claim 2, wherein the mixed acid solution contains nitric acid and the wafer surface is a silicon surface, wherein the chemical reactions involved in the wet etching process which is performed on the wafer surface using the mixed acid solution include:
$${HNO}_{3} + {H}^{+} {{⇌}_{{k}_{- 5}}}^{{k}_{5}} {NO}_{2}^{+} + {H}_{2} O$$
$${NO}_{2}^{+} + {e}^{-} {{⇌}_{{k}_{- 6}}}^{{k}_{6}} {NO}_{2}$$
$${NO}_{2} + {H}_{3}^{+} O {{⇌}_{{k}_{- 7}}}^{{k}_{7}} {HNO}_{2} + {H}_{2} O$$
$${HNO}_{3} + 2 NO + {H}_{2} O {\to }^{{k}_{8}} 3 {HNO}_{2}$$
$$2 {HNO}_{2} + Si {\to }^{{k}_{9}} {SiO}_{2} + {N}_{2} O + {H}_{2} O$$
$${N}_{2} O + 4 {NO}_{2} + 3 {H}_{2} O {\to }^{{k}_{10}} 6 {HNO}_{2}$$
where k₅, k₋₅, k₆, k₋₆, k₇, k₋₇, k₈, k₉ and k₁₀ are reaction constants, and HNO₂ is identified as the activator and N₂O as the inhibitor according to the Brusselator model.

4. The method of modeling a wet etching process of claim 3, wherein the formulas for the chemical reaction functions obtained by applying the Brusselator model to the chemical reaction functions are
$${f}_{X} ( X , Y ) = {k}_{8} {C}_{{HNO}_{3}} {C}_{NO}^{2} + {k}_{7} {C}_{{NO}_{2}} - {k}_{- 7} X - {k}_{9} {X}^{2} + \frac{{k}_{10}}{{k}_{7}^{4}} {X}^{4} Y$$
$${f}_{Y} ( X , Y ) = {k}_{9} {X}^{2} - \frac{{k}_{10}}{{k}_{7}^{4}} {X}^{4} Y$$
$$where$$
$${k}_{7} = \frac{[ {HNO}_{2} ]}{[ {NO}_{2} ]} = \frac{{C}_{{HNO}_{2}}}{{C}_{{NO}_{2}}} = \frac{X}{{C}_{{NO}_{2}}} ,$$
and C_{HNO}_{₃}, C_{NO}, C_{NO}_{₂} and C_{HNO}_{₂} are molar concentrations of HNO₃, NO, NO₂ and HNO₂, respectively.

5. The method of modeling a wet etching process of claim 4, wherein determining the conditions for developing a chemical clock for the chemical reactions in the wet etching process comprises:
normalizing reaction coefficients in the formulas for the chemical reaction functions, thereby simplifying the formulas for the chemical reaction functions into:
ƒ_{X}(X,Y)=C−AX−X²+BX⁴Y,
ƒ_{Y}(X,Y)=X²−BX⁴Y, where A,B,C are the simulation parameters;
linearizing and expanding the simplified formulas for the chemical reaction functions, thereby further simplifying the formulas for the chemical reaction functions into:
ƒ_{X}(X,Y)=ax+bY,
ƒ_{Y}(X,Y)=cX+dY;
letting the linearized and expanded formulas for the chemical reaction functions satisfy the following equations at a pole (X₀, Y₀):
ƒ_{X}(X₀,Y₀)=0,
ƒ_{Y}(X₀,Y₀)=0;
according to the nonlinear system theory, determining the conditions for developing a chemical clock for the chemical reactions as the following conditions for the system to have a limit cycle around the pole (X₀, Y₀):
a+d=0,
ad−bc>0.

6. The method of modeling a wet etching process of claim 5, wherein calculating the simulation parameters of the formulas for the chemical reaction functions comprises:
measuring an amount of silicon etched away from the wafer surface;
estimating ranges of the reaction constants based on the measurement;
calculating the reaction constants based on the estimated ranges according to the equations satisfied at the pole and the conditions for obtaining a limit cycle around the pole; and
calculating the simulation parameters of the formulas for the chemical reaction functions based on the calculated reaction constants and on the normalization of the reaction coefficients in the formulas for the chemical reaction functions.

7. The method of modeling a wet etching process of claim 6, wherein determining the diffusion coefficients in the spatial diffusion terms, which allow formation of dome-shaped micro-cavities, comprises:
with the calculated reaction constants being kept constant, estimating diffusion coefficients of the activator and the inhibitor from an actual viscosity measurement of the mixed acid solution as initial values and performing a simulation process using a difference iteration approach such that the activator and the inhibitor exhibit spatially periodic concentration profiles, thereby determining the diffusion coefficients of the activator and the inhibitor.

8. The method of modeling a wet etching process of claim 3, wherein the mixed acid solution further contains hydrofluoric acid and sulfuric acid.

9. A method of manufacturing a semiconductor device, comprising:
using the method of modeling a wet etching process of claim 1 to establish a mathematical model of a reaction-diffusion system for chemical reactions involved in a wet etching process on a wafer surface;
using the mathematical model to simulate formation of dome-shaped micro-cavities formed on the wafer surface as a result of the wet etching process and thereby obtaining an optimal mixture ratio of a mixed acid solution used in the wet etching process; and
etching the wafer surface using the mixed acid solution with the optimal mixture ratio.

10. The method of manufacturing a semiconductor device of claim 9, wherein the mixed acid solution with the optimal mixture ratio is used to etch a substrate on the backside of the wafer to form morphologically optimal dome-shaped micro-cavities on a surface of the substrate, wherein the method of manufacturing a semiconductor device further comprises forming a metal electrode on the surface of the substrate.
